(19) United States
(12) Patent Application Publication
(10) Pub. No.: US 2024/0001996 A1
(43) Pub. Date: Jan. 4, 2024

(54) FENDER LINER AND METHOD OF INSTALLING

(71) Applicants: Caleb Rupp, Sturgis, SD (US); Brian Edward Beaudin, Rapid City, SD (US); Eric James Krebs, Rapid City, SD (US)

(72) Inventors: Caleb Rupp, Sturgis, SD (US); Brian Edward Beaudin, Rapid City, SD (US); Eric James Krebs, Rapid City, SD (US)

(21) Appl. No.: 18/215,523

(22) Filed: Jun. 28, 2023

Related U.S. Application Data
(60) Provisional application No. 63/356,848, filed on Jun. 29, 2022.

(51) Int. Cl. B62D 25/16; B62D 25/18

(52) U.S. Cl. CPC B62D 25/163; B62D 25/18

(57) ABSTRACT

A method of modifying a vehicle can include removing an existing fender liner from a wheel well of the vehicle. A cut guide can be aligned with landmarks of a fender of the vehicle. The cut guide can be secured to the fender or a fender flair that is secured to the fender, and the cut guide can be secured to the fender around at least a portion of the wheel well of the vehicle. The fender can be cut along the cut guide to increase a size of the wheel well. A fender liner bracket can be secured to the vehicle. A replacement fender liner can be secured to the fender liner bracket. The replacement fender liner can be secured to an existing bracket of the vehicle.

### CLAIM OF PRIORITY

This patent application claims the benefit of priority, under 35 U.S.C. Section 119(e), to Caleb Rupp, U.S. Patent Application Ser. No. 63/356,848, entitled “FENDER LINER AND METHOD OF INSTALLING,” filed on Jun. 29, 2022, which is hereby incorporated by reference herein in its entirety.

### BACKGROUND

Automobiles, including cars and trucks, are widely used for transportation, exploration, and sport. Some vehicles used for these purposes can be designed to operate off-road or to traverse surfaces other than those that are paved. For example, vehicles can be designed to traverse mud, dirt, sand, or boulders. Such vehicles are often modified from their production or factory version to improve driving performance on non-paved surfaces.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates an isometric view of a fender liner.

FIG. 1B illustrates a front view of a fender liner.

FIG. 1C illustrates a side view of a fender liner.

FIG. 2A illustrates an isometric view of a fender liner.

FIG. 2B illustrates a front view of a fender liner.

FIG. 2C illustrates a side view of a fender liner.

FIG. 3A illustrates a side view of a cut guide.

FIG. 3B illustrates a cross-sectional view of a cut guide across indicators B-B of FIG. 3A.

FIG. 4 illustrates a side view of a cut guide.

FIG. 5 illustrates a portion of a vehicle undergoing a modification process.

FIG. 6 illustrates a portion of a vehicle undergoing a modification process.

FIG. 7 illustrates a portion of a vehicle undergoing a modification process.

FIG. 8 illustrates a portion of a vehicle undergoing a modification process.

FIG. 9 illustrates a portion of a vehicle undergoing a modification process.

FIG. 10 illustrates a portion of a vehicle undergoing a modification process.

FIG. 11A illustrates a portion of a vehicle for a modification process.

FIG. 11B illustrates a portion of a vehicle undergoing a modification process.

FIG. 11C illustrates a portion of a vehicle undergoing a modification process.

FIG. 11D illustrates a portion of a vehicle undergoing a modification process.

FIG. 12 illustrates a portion of a vehicle undergoing a modification process.

FIG. 13A illustrates a portion of a vehicle undergoing a modification process.

FIG. 13B illustrates a portion of a vehicle undergoing a modification process.

FIG. 14A illustrates a perspective exploded view of a portion of a body mount assembly.

FIG. 14B illustrates a perspective exploded view of a portion of a body mount assembly.

FIG. 15 illustrates a schematic view of a method of installing one or more components onto a vehicle.

### DETAILED DESCRIPTION

Off-road vehicles are often designed to traverse or drive through, mud sand, grass, rocks, boulders, or the like. Such vehicles are often modified from their factory form, as many vehicles, while reliable, are designed to primarily traverse paved or flat and consistent surfaces. Some modifications commonly made to off-road vehicles including improving suspension components, increasing ground clearance, and increasing tire size. While larger tires often fit on the hub and within a wheel well of a factory vehicle, tires significantly larger than standard can decrease suspension travel and increase a likelihood of the tires rubbing on body components, such as fenders, during turning of the wheels. The body can be modified to help reduce tire rubbing and increase suspension travel; however, such modifications can require time-consuming and expensive custom modifications.

The present application helps to address these issues by providing an assembly and methods for modifying a production vehicle to accommodate large tires, such as for increased off-road performance. The assembly can include new body mounts for providing increased tire clearance and can include replacement fender liners following modification of the body. The assembly can further include cut guides for providing guidance in cutting the fenders accurately for increasing tire clearance and for accepting the after-market fender liners. These components and the methods discussed below can help to modify a production vehicle to accommodate larger tires without rubbing of the tires on the frame or body and to allow proper suspension travel once the tires are installed.

The above discussion is intended to provide an overview of subject matter of the present patent application. It is not intended to provide an exclusive or exhaustive explanation of the invention. The description below is included to provide further information about the present patent application.

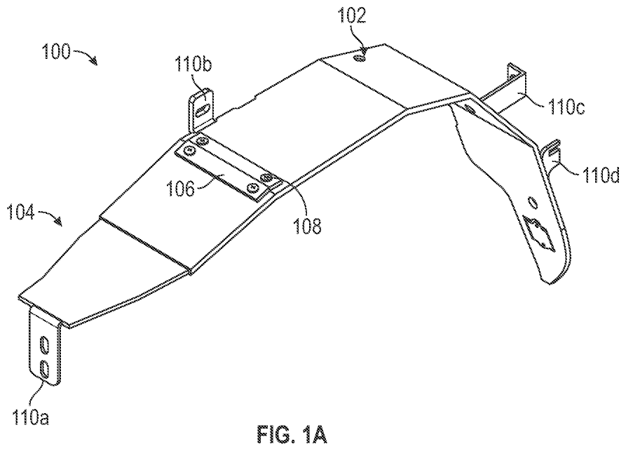

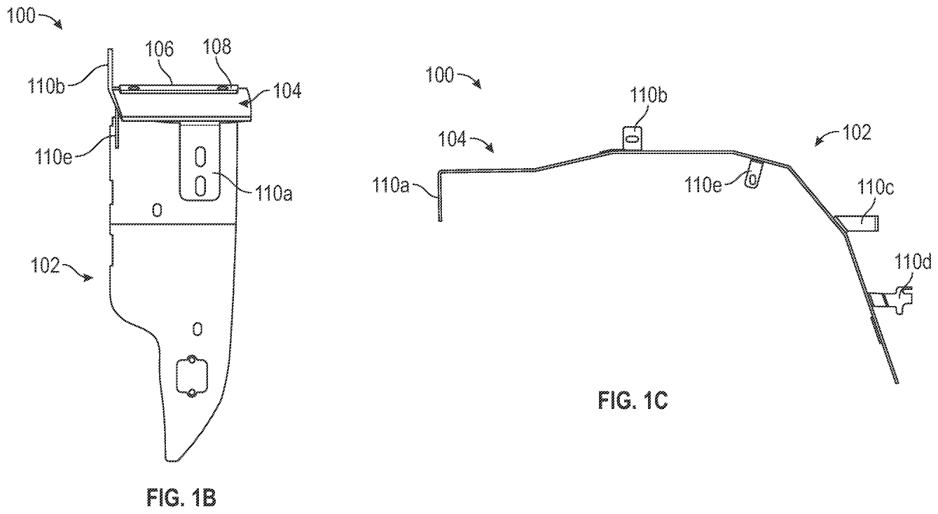

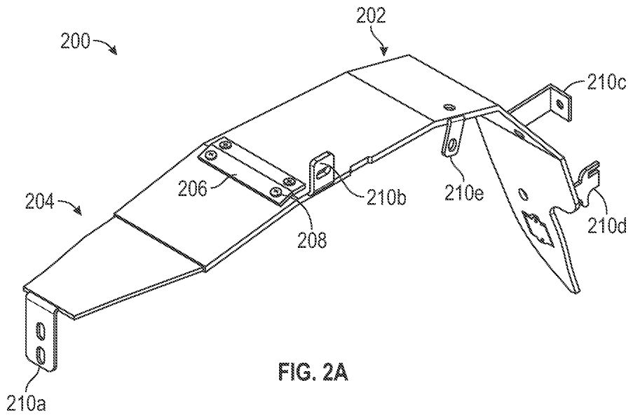

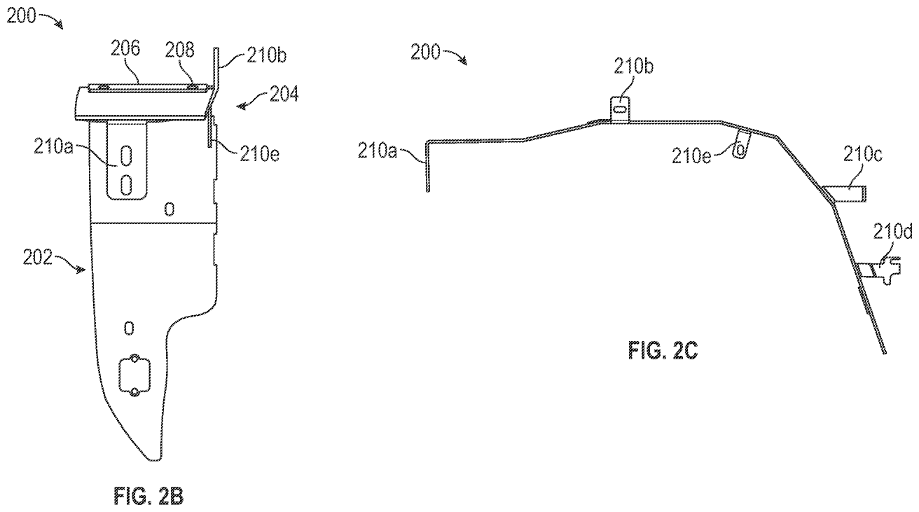

FIG. 1A illustrates an isometric view of a fender liner 100. FIG. 1B illustrates a front view of the fender liner 100. FIG. 1C illustrates a side view of the fender liner 100. FIG. 2A illustrates an isometric view of a fender liner 200. FIG. 2B illustrates the front view of a fender liner 200. FIG. 2C illustrates a side view of the fender liner 200. FIGS. 1A-2C are discussed together below.

The fender liner 100 can be a driver side fender liner and the fender liner 200 can be a passenger side fender liner. The fender liners can, for example, be mirror copies of each other. The fender liners can be configured to replace a stock fender liner of a vehicle, such as a Toyota 4-Runner or a Toyota Tacoma; however, the components and the methods discussed herein can be applied to other vehicles, such as cars, trucks, side-by-sides, offroad vehicles, SUVS, or the like.

The fender liner 100 can include a first portion 102 and a second portion 104, which can be front and rear portions. For example, the first portion 102 can be a rear portion and the second portion 104 can be a front portion. The first portion 102 and the second portion 104 can be connectable, such as by a bracket or mounting plate 106 and one or more fasteners (e.g., screws, rivets, bolts, or the like) 108.

The fender liner 100 can also include one or more brackets 110a-110e that can be securable to the first portion 102 and the second portion 104 and to a vehicle frame or body for securing the fender liner fender liner 100 to a driver's side of a vehicle. For example, a front liner bracket 110a can connected to the second portion 104 and can be securable to a body of the vehicle. The liner 100 can also include inner brackets 110b, 110c, 110d, and 110e that can be connected to or extend from a laterally inner portion of the first portion 102 of the fender liner 100. Also, one or more of the brackets 110 can be secured to a fender line bracket, discussed below.

Similarly, the fender liner 200 can include a first portion 202 and a second portion 204, which can be front and rear portions. For example, the first portion 202 can be a rear portion and the second portion 204 can be a front portion. The first portion 202 and the second portion 204 can be connectable, such as by a bracket or mounting plate 206 and one or more fasteners (e.g., screws, rivets, bolts, or the like) 208. The fender liner 200 can also include one or more brackets 210a-210e that can be securable to the first portion 202 and the second portion 204 and to a vehicle frame or body for securing the fender liner fender liner 200 to a driver's side of a vehicle.

The fender liner 200 can also include one or more brackets 210a-210e that can be securable to the first portion 202 and the second portion 204 and to a vehicle frame or body for securing the fender liner fender liner 200 to a driver's side of a vehicle. For example, a front liner bracket 210a can be connected to the second portion 204 and can be securable to a body of the vehicle. The liner 200 can also include inner brackets 210b, 210c, 210d, and 210e that can be connected to or extend from a laterally inner portion of the first portion 202 of the fender liner 200. Also, one or more of the brackets 210 can be secured to a fender line bracket, discussed below.

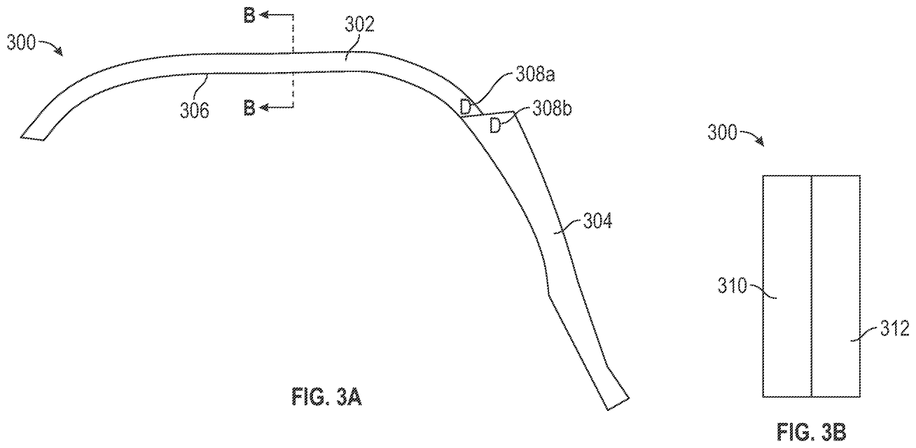

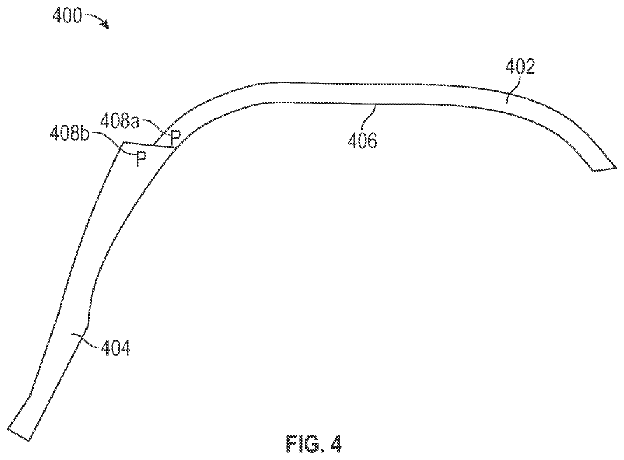

FIG. 3A illustrates a side view of a cut guide 300. FIG. 3B illustrates a cross-sectional view of the cut guide 300 across indicators B-B of FIG. 3A. FIG. 4 illustrates a side view of a cut guide 400. FIGS. 3A-4 are discussed together below. The cut guide 300 of FIG. 3 can be a driver side cut guide and the cut guide 400 of FIG. 4 be a passenger cut guide. The cut guides can, for example, be mirror copies of each other.

The cut guide 300 can include a top piece or portion 302 and a bottom piece or portion 304 that can be connectable to the portion 302. The portion 302 and the portion 304 can be connectable to an outer surface of a vehicle such as around a wheel well of the vehicle. The cut guide 300 can be securable to the outer surface of the vehicle using fasteners or an adhesive, such as a pressure-sensitive adhesive, static adhesion, or a temporary adhesive. The cut guides can include placement guides 308a and 308b, such as “D” for indicating a proper placement side (i.e., driver side) for trimming of the proper vehicle side using the proper cut guide. The cut guide 300, when the portion 302 and the portion 304 are connected and secured to the vehicle, can provide a template or guide edge 306 for a user to cut along for modification of the fender flare or fender of a vehicle.

Similarly, the cut guide 400 can include a top piece or portion 402 and a bottom piece or portion 404 that can be connectable to the portion 402. The portion 402 and the portion 404 can be connectable to an outer surface of a vehicle such as around a wheel well of the vehicle. The cut guide 400 can be securable to the outer surface of the vehicle using fasteners or an adhesive, such as a pressure-sensitive adhesive, static adhesion, or a temporary adhesive. The cut guides can include placement guides 308a and 308b, such as “P” for indicating a proper placement side (i.e., passenger side) for trimming of the proper vehicle side using the proper cut guide. The cut guide 400, when the portion 402 and the portion 404 are connected and secured to the vehicle, can provide a template or guide edge 406 for a user to cut along for modification of the fender flare or fender of a vehicle.

Also, either or both of the cut guides 300 and 400 can be alignable with landmarks of a fender of the vehicle, such as a seam, end or the like, of a fender. The cut guides 300 or 400 can also be securable to the fender or a fender flair that is secured to the fender. Also, as shown in FIG. 3B, the cut guide 300 can include a first layer 310 and a second layer 312. The first layer 310 can be made of vinyl, polyester, polypropylene, satin, or the like. The second layer 312 can be bonded to or connected to the first layer 310 and the second layer 312 can be an adhesive securable (such as releasably securable) to the fender or fender flair of the vehicle. The adhesive can be a temporary adhesive configured to hold the cut guide 300 in place during cutting, but can be removable without heat or a solvent. The cut guide 300 can optionally include a third layer that can be a substrate. The cut guide 400 can be similarly configured to the cut guide 300.

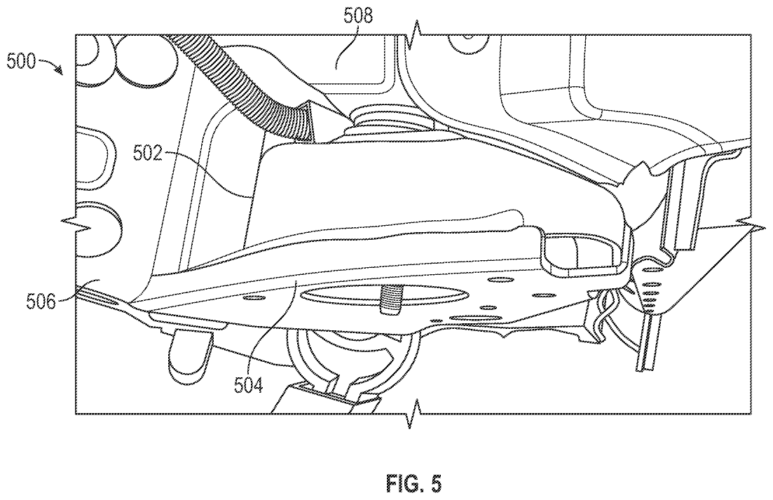

FIGS. 5-13B shows steps of modifying a vehicle for acceptance of tires larger than factory standard. FIGS. 5-13B are discussed together below. FIG. 5 illustrates a portion of a vehicle 500 undergoing a modification process of demarking material to be removed from a body mount. For example, a line 502 is shown where a cab mount 504 can be trimmed or cut from a frame 506 of the vehicle 500, where the existing cab mount 504 can be secured (e.g., bolted) to a cab 508 of the vehicle 500.

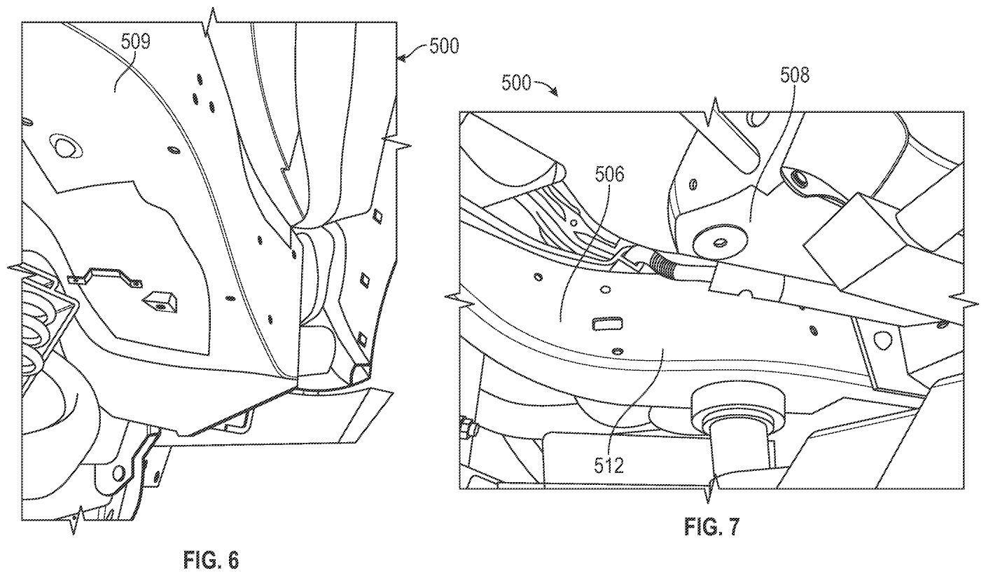

FIG. 6 illustrates a portion of the vehicle 500 undergoing a modification process, such as the underside of a body 509 with a factory fender liner removed. FIG. 7 illustrates a portion of the vehicle 500 undergoing a modification process, such as following grinding or cutting away of the stock or standard cab mount 504, revealing a portion 512 of the 506 to which the stock or existing cab mount 504 was secured (e.g., welded).

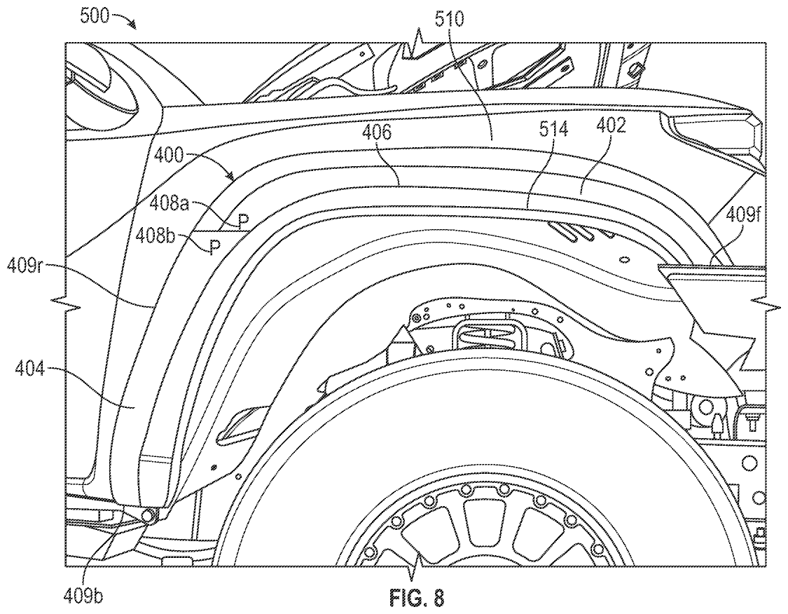

FIG. 8 illustrates a portion of the vehicle 500 undergoing a modification process, such as the passenger side cutting guide 400 adhered to a fender flare 514 that is secured to the fender 510 of the 500. As shown in FIG. 8, edge 409f of the portion 402 can be aligned with an edge of the fender 510 and the fender flare 514, edge 409b of the portion 404 can be aligned with a rear and bottom portion of the fender 510 and the fender flare 514, and edge 409r can be aligned with a rear portion of the fender 510 and the fender flare 514 to properly align the cut guide 400 on the fender 510 and the fender flare 514 such that the edge 406 is in a predetermined location for resecting, cutting, or removing a portion of the fender flare 514 and the fender 510. Optionally, the fender flare 514 can be removed from the fender 510 and the cut guide 400 can be applied only to the fender flare 514 for trimming or cutting of the fender flare 514 and then the cut guide 400 can be removed from the modified fender flare 514 and applied to the fender 510 for cutting of the fender 510. The order of these steps can be optionally reversed.

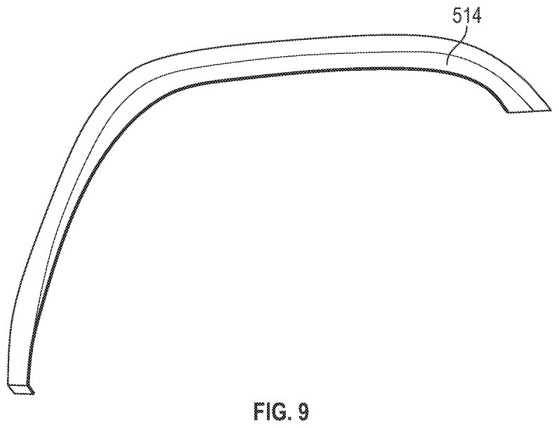

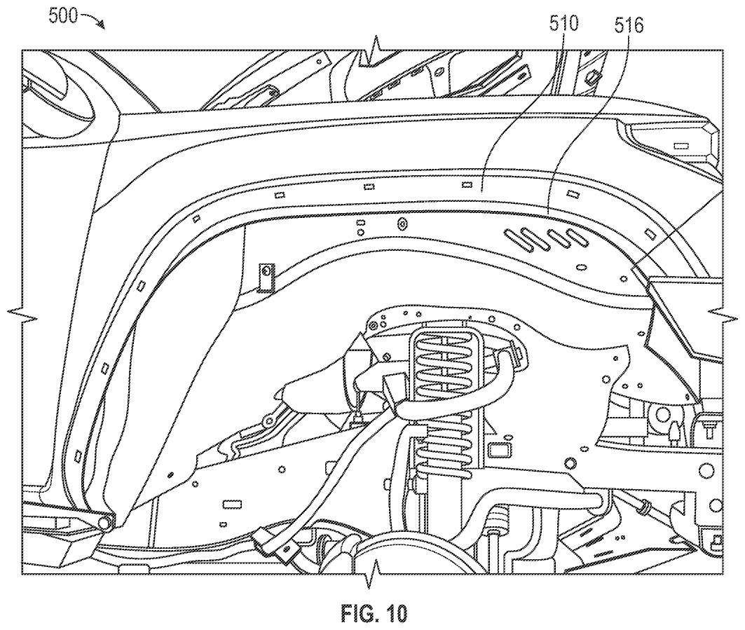

FIG. 9 illustrates a portion of a vehicle undergoing a modification process, such as a trimmed fender flare 514 following use of the cutting guide 400 to cut or trim the fender flare. FIG. 10 illustrates a portion of a vehicle undergoing a modification process, such as the 510 fender following cutting of the fender 510 using the cutting guide 400 and following removal of the fender flare, and showing how a wheel well 516 of the fender 510 can be enlarged following trimming of the fender 510 to allow the vehicle 500 to accept a larger diameter tire without rubbing (or with less rubbing that prior to the fender 510 being trimmed).

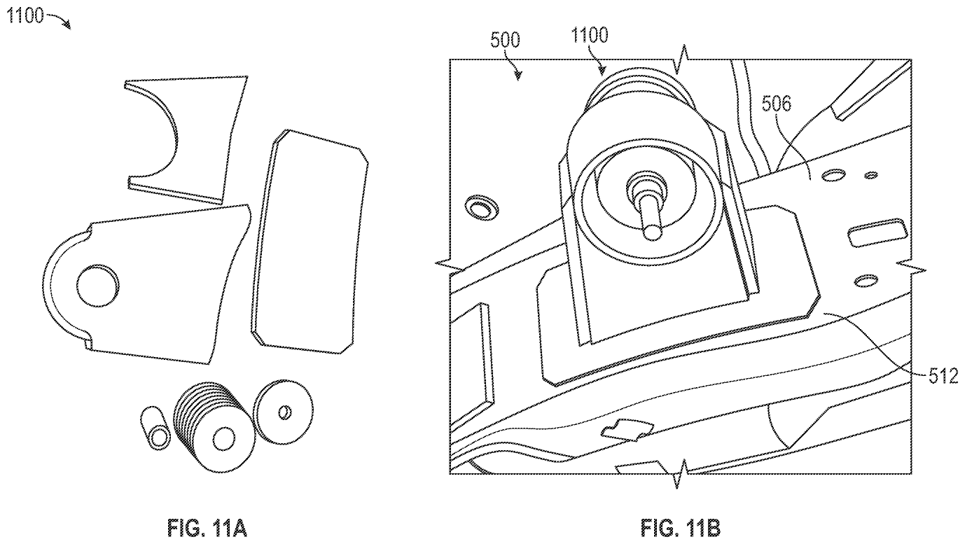

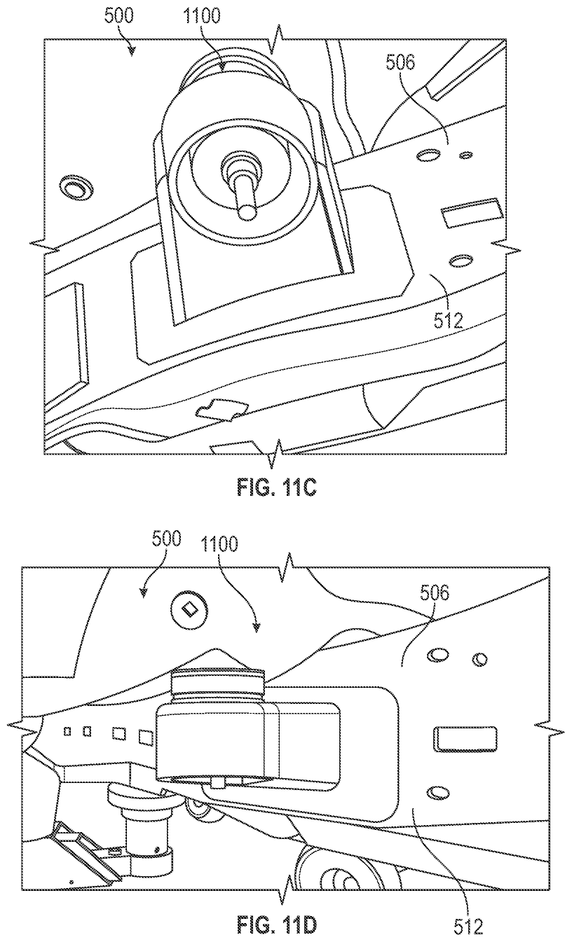

FIG. 11A illustrates a portion of a body mount assembly 100 securable to the frame 506 of the vehicle 500 following removal of the factory body mount. FIG. 11B illustrates a test fit of the body mount 100 assembly on the frame of the body prior to installation. FIG. 11A also shows that the fender liner 100 can include a body, a mounting plate, a cover plate, a bushing, and other hardware. FIGS. 11C shows the body mount assembly 1100 (replacement cab mount) following securing (e.g., welding or bolting) of the body mount 1100 to the frame 506 of the vehicle 500, such as to the portion 512. FIG. 11D shows the vehicle 500 following securing of the body mount 100 to the cab 504, such as using one or more bushings, washers, buts and bolts.

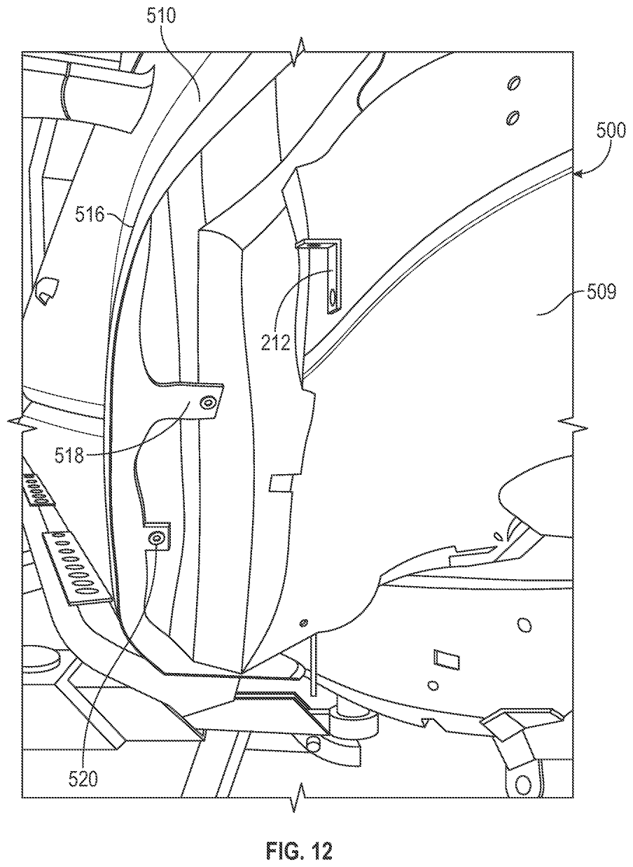

FIG. 12 illustrates a bracket 212 of the fender liner 200 connected to the body 509 of the vehicle 500. FIG. 12 also shows brackets 518 and 520 secured to the 509 of the vehicle which can be existing brackets of the 500. Optionally, the bracket 212 can be secured to one or more existing openings or bores of the body 509 of the vehicle 500.

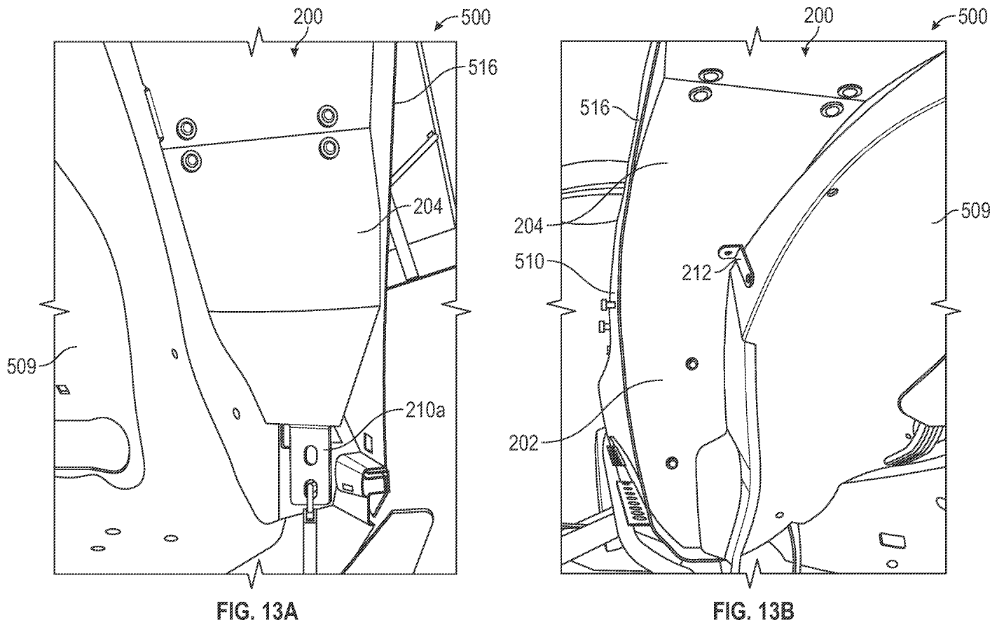

FIG. 13A shows the front portion 204 of the fender liner 200 secured to a rear portion 202 of the fender liner 200 and secured to the body 509 of the vehicle 500. FIG. 13B shows front portion 204 of the fender liner secured to the rear portion 202 of the fender liner 200 and secured to the body 509 of the vehicle 500. FIG. 13B also shows the bracket 212 secured to the body 509 and secured to the first portion 202 of the fender liner 200.

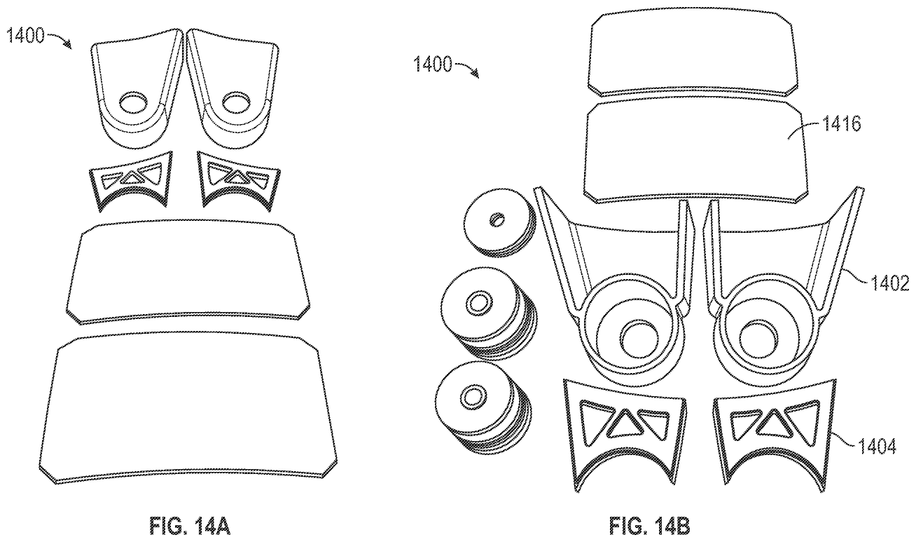

FIG. 14A illustrates a perspective exploded view of a portion of an alternate body mount assembly 1400. FIG. 14B illustrates a perspective exploded view of a portion of the alternate body mount assembly 1400. The alternate body mount assembly 1400 can be similar to the body mount assembly 1100 and can be used in any of the modification methods discussed herein. In the alternate body mount assembly 1400, a cover plate 1404 securable to a body 1402, where the body 1402 can be secured to a mounting plate 1416 and the mounting plate 1416 can be welded to the frame 506. The cover plate 1404 can include multiple holes therein or therethrough to help reduce weight of the alternate body mount assembly 1400 and to allow drainage out of the alternate body mount assembly 1400 near the bushings and bolts of the alternate body mount assembly 1400.

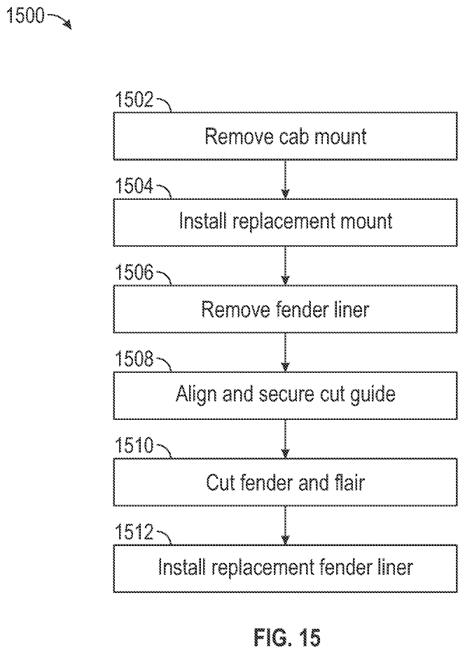

FIG. 15 is illustrates a schematic view of a method 1500. The method 1500 can be a method of installing one or more components onto a vehicle. More specific examples of the method 1500 are discussed below. The steps or operations of the method 1500 are illustrated in a particular order for convenience and clarity; many of the discussed operations can be performed in a different sequence or in parallel without materially impacting other operations. The method 1500 as discussed includes operations performed by multiple different actors, devices, or systems. It is understood that subsets of the operations discussed in the method 1500 can be attributable to a single actor, device, or system could be considered a separate standalone process or method.

The method 1500 can begin at step 1502 where a cab mount can be removed from a frame of a vehicle. For example, the existing cab mount 504 can be cut or trimmed from the frame 506 (and can be unbolted from the cab 508). At step 1504, a replacement cab mount can be secured to the frame of the vehicle. For example, the body mount assembly 1100 can be secured to the frame 506.

At step 1506 an existing fender liner can be removed from a wheel well of the vehicle. For example a liner can be removed from the well 516 of the vehicle 500. At step 1508, a cut guide can be aligned with landmarks of a fender of the vehicle and the cut guide can be secured to the fender or a fender flair that is secured to the fender, where the cut guide can be secured to the fender around at least a portion of the wheel well of the vehicle. For example, the cut guide 400 can be aligned with landmarks (e.g., edges) of the fender 510 of the vehicle 500. Also, the cut guide 400 can be secured to the fender 510 or the fender flair 514 that is secured to the fender 510, where the cut guide 400 can be secured to the fender 510 around at least a portion of the wheel well 516 of the vehicle 500.

At step 1510, the fender can be cut or trimmed along the cut guide to increase a size of the wheel well. For example, the fender 510 can be cut or trimmed along the edge 406 of the cut guide 400 to increase a size of the wheel well 516. At step 1512, a fender liner bracket can be secured to the vehicle and a replacement fender liner can be secured to a fender liner bracket. For example, a fender liner bracket 212 can be secured to the vehicle 500 and a replacement fender liner 200 can be secured to a fender liner bracket 212.

Optionally, the replacement fender liner 200 can be secured to an existing bracket of the vehicle. Optionally, the front portion 204 of the replacement fender liner 200 can be to the rear portion 202 of the replacement fender 200 liner using a mounting plate 206. Optionally, a plurality of liner brackets 210 can be secured to the vehicle 500. Optionally, a front liner bracket 210a can be secured to the body 509 of the vehicle 500. Optionally, the fender flair 514 can be cut by cutting along the cut guide 400. In some examples, the cut guide can include an adhesive layer securable to the fender or the fender flair. In some examples, the fender liner bracket can be secured to a laterally inner portion of the replacement fender liner.

### NOTES AND EXAMPLES

The following, non-limiting examples, detail certain aspects of the present subject matter to solve the challenges and provide the benefits discussed herein, among others.

Example 1 is a method of modifying a vehicle, the method comprising: removing an existing fender liner from a wheel well of the vehicle; aligning a cut guide with landmarks of a fender of the vehicle; securing the cut guide to the fender or a fender flair that is secured to the fender, the cut guide secured to the fender around at least a portion of the wheel well of the vehicle; cutting the fender along the cut guide to increase a size of the wheel well; securing a fender liner bracket to the vehicle; securing a replacement fender liner to the fender liner bracket; and securing the replacement fender liner to an existing bracket of the vehicle.

In Example 2, the subject matter of Example 1 includes, fastening a front portion of a replacement fender liner to a rear portion of the replacement fender liner using a mounting plate.

In Example 3, the subject matter of Example 2 includes, removing an existing cab mount from a frame of the vehicle; securing a replacement cab mount to the frame of the vehicle; and securing the replacement cab mount to a cab of the vehicle.

In Example 4, the subject matter of Examples 1-3 includes, wherein the cut guide includes an adhesive layer securable to the fender or the fender flair.

In Example 5, the subject matter of Examples 1-4 includes, wherein the fender liner bracket is secured to a laterally inner portion of the replacement fender liner.

In Example 6, the subject matter of Example 5 includes, securing a plurality of liner brackets to the vehicle.

In Example 7, the subject matter of Examples 5-6 includes, securing a front liner bracket to a body of the vehicle; and securing three inner liner brackets to the body of the vehicle.

In Example 8, the subject matter of Examples 1-7 includes, cutting the fender flair by cutting along the cut guide.

Example 9 is an assembly for modifying a vehicle, the assembly comprising: a cut guide alignable with landmarks of a fender of the vehicle, the cut guide securable to the fender or a fender flair that is secured to the fender, the cut guide securable to the fender around at least a portion of a wheel well of the vehicle, and the cut guide configured to guide cutting of the fender to enlarge the wheel well of the vehicle; a fender liner bracket securable to an existing bore of a body of the vehicle; a replacement fender liner comprising: a front portion; a mounting plate; a rear portion securable to the front portion using the mounting plate; a front liner bracket securable to the body of the vehicle; and a plurality of inner liner brackets extending from a laterally inner side the rear portion, the plurality of inner liner brackets securable to the body of the vehicle; and a replacement cab mount securable to a frame of the vehicle and securable to a cab of the vehicle to secure the cab to the frame.

In Example 10, the subject matter of Example 9 includes, wherein the replacement cab mount is securable to the frame at a location of the frame to which an existing cab mount is connected.

In Example 11, the subject matter of Examples 9-10 includes, wherein the cut guide includes an adhesive layer securable to the fender or the fender flair.

In Example 12, the subject matter of Examples 9-11 includes, wherein the fender liner bracket is secured to a laterally inner portion of the replacement fender liner.

In Example 13, the subject matter of Examples 9-12 includes, wherein the rear portion and the front portion are securable to the mounting plate by a plurality of fasteners.

Example 14 is an assembly for modifying a vehicle, the assembly comprising: a cut guide alignable with landmarks of a fender of the vehicle, the cut guide securable to the fender or a fender flair that is secured to the fender, the cut guide securable to the fender around at least a portion of a wheel well of the vehicle, and the cut guide configured to guide cutting of the fender to enlarge the wheel well of the vehicle; a fender liner bracket securable to an existing bore of a body of the vehicle; and a replacement fender liner comprising: a front portion; a mounting plate; a rear portion securable to the front portion using the mounting plate; a front liner bracket securable to the body of the vehicle; and a plurality of inner liner brackets extending from a laterally inner side the rear portion, the plurality of inner liner brackets securable to the body of the vehicle.

In Example 15, the subject matter of Example 14 includes, wherein the cut guide includes an adhesive layer securable to the fender or the fender flair.

In Example 16, the subject matter of Examples 14-15 includes, wherein the fender liner bracket is secured to a laterally inner portion of the replacement fender liner.

In Example 17, the subject matter of Examples 14-16 includes, wherein the rear portion and the front portion are securable to the mounting plate by a plurality of fasteners.

Example 18 is at least one machine-readable medium including instructions that, when executed by processing circuitry, cause the processing circuitry to perform operations to implement of any of Examples 1-17.

Example 19 is an apparatus comprising means to implement of any of Examples 1-17.

Example 20 is a system to implement of any of Examples 1-17.

Example 21 is a method to implement of any of Examples 1-17.

In Example 22, the apparatuses or method of any one or any combination of Examples 1-21 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of modifying a vehicle, the method comprising:
removing an existing fender liner from a wheel well of the vehicle;
aligning a cut guide with landmarks of a fender of the vehicle;
securing the cut guide to the fender or a fender flair that is secured to the fender, the cut guide secured to the fender around at least a portion of the wheel well of the vehicle;
cutting the fender along the cut guide to increase a size of the wheel well;
securing a fender liner bracket to the vehicle;
securing a replacement fender liner to the fender liner bracket; and
securing the replacement fender liner to an existing bracket of the vehicle.

2. The method of claim 1, comprising:
fastening a front portion of a replacement fender liner to a rear portion of the replacement fender liner using a mounting plate.

3. The method of claim 2, comprising:
removing an existing cab mount from a frame of the vehicle;
securing a replacement cab mount to the frame of the vehicle; and
securing the replacement cab mount to a cab of the vehicle.

4. The method of claim 1, wherein the cut guide includes an adhesive layer securable to the fender or the fender flair.

5. The method of claim 1, wherein the fender liner bracket is secured to a laterally inner portion of the replacement fender liner.

6. The method of claim 5, comprising:
securing a plurality of liner brackets to the vehicle.

7. The method of claim 5, comprising:
securing a front liner bracket to a body of the vehicle; and
securing three inner liner brackets to the body of the vehicle.

8. The method of claim 1, comprising:
cutting the fender flair by cutting along the cut guide.

9. An assembly for modifying a vehicle, the assembly comprising:
a cut guide alignable with landmarks of a fender of the vehicle, the cut guide securable to the fender or a fender flair that is secured to the fender, the cut guide securable to the fender around at least a portion of a wheel well of the vehicle, and the cut guide configured to guide cutting of the fender to enlarge the wheel well of the vehicle;
a fender liner bracket securable to an existing bore of a body of the vehicle;
a replacement fender liner comprising:
a front portion;
a mounting plate;
a rear portion securable to the front portion using the mounting plate;
a front liner bracket securable to the body of the vehicle; and
a plurality of inner liner brackets extending from a laterally inner side the rear portion, the plurality of inner liner brackets securable to the body of the vehicle; and
a replacement cab mount securable to a frame of the vehicle and securable to a cab of the vehicle to secure the cab to the frame.

10. The assembly of claim 9, wherein the replacement cab mount is securable to the frame at a location of the frame to which an existing cab mount is connected.

11. The assembly of claim 9, wherein the cut guide includes an adhesive layer securable to the fender or the fender flair.

12. The assembly of claim 9, wherein the fender liner bracket is secured to a laterally inner portion of the replacement fender liner.

13. The assembly of claim 9, wherein the rear portion and the front portion are securable to the mounting plate by a plurality of fasteners.

14. An assembly for modifying a vehicle, the assembly comprising:
a cut guide alignable with landmarks of a fender of the vehicle, the cut guide securable to the fender or a fender flair that is secured to the fender, the cut guide securable to the fender around at least a portion of a wheel well of the vehicle, and the cut guide configured to guide cutting of the fender to enlarge the wheel well of the vehicle;
a fender liner bracket securable to an existing bore of a body of the vehicle; and
a replacement fender liner comprising:
a front portion;
a mounting plate;
a rear portion securable to the front portion using the mounting plate;
a front liner bracket securable to the body of the vehicle; and
a plurality of inner liner brackets extending from a laterally inner side the rear portion, the plurality of inner liner brackets securable to the body of the vehicle.

15. The assembly of claim 14, wherein the cut guide includes an adhesive layer securable to the fender or the fender flair.

16. The assembly of claim 14, wherein the fender liner bracket is secured to a laterally inner portion of the replacement fender liner.

17. The assembly of claim 14, wherein the rear portion and the front portion are securable to the mounting plate by a plurality of fasteners.
